(19) United States
(12) Patent Application Publication
(10) Pub. No.: US 2025/0031771 A1
(43) Pub. Date: Jan. 30, 2025

(54) CHARGING SAFETY CUT-OFF

(71) Applicant: Philip Morris Products S.A., Neuchatel (CH)

(72) Inventors: Michel BESSANT, Neuchâtel (CH); Stéphane BILAT, Cortaillod (CH); Philip NAYLOR, Lausanne (CH)

(73) Assignee: Philip Morris Products S.A., Neuchatel (CH)

(21) Appl. No.: 18/714,168

(22) PCT Filed: Dec. 7, 2022
(86) PCT No.: PCT/EP2022/084856

§ 371 Date: May 29, 2024

(30) Foreign Application Priority Data
Dec. 10, 2021 (EP) 21213807.7

(51) Int. Cl. A24F 40/95; H02J 7/00

(52) U.S. Cl. CPC A24F 40/95; H02J 7/00302; H02J 7/0048; H02J 7/00716; H02J 7/007182

(57) ABSTRACT

A method for charging a rechargeable lithium-ion battery in an aerosol-generating system is provided, the method including: initiating charging of the rechargeable lithium-ion battery; monitoring an electrical parameter indicative of a charging rate of the rechargeable lithium-ion battery; determining the charging rate of the rechargeable lithium-ion battery by monitoring a change of the electrical parameter over a given time period; and comparing the determined charging rate to a reference charging rate, the reference charging rate being defined by an expected change in the monitored electrical parameter; and if the charging rate deviates from the reference charging rate, inhibiting the rechargeable lithium-ion battery from being charged. A charge controller for an aerosol generating system is also provided. An aerosol-generating device is also provided. A charging case for an aerosol generating device is also provided.

The present invention relates to a method for safely charging a battery in an aerosol-generating system and to an aerosol-generating system implementing said method. The present invention also relates to an aerosol-generating device and a charging case to be used in the aerosol-generating system.

Commonly known aerosol-generating systems are portable and electrically operated and typically include re-chargeable batteries to provide the required electrical power. It is critical to charge a battery in an aerosol-generating system in a safe manner—otherwise, the battery can become unstable which can lead to catastrophic failure of the aerosol generating device. This is particularly important in aerosol-generating systems since these systems typically generate heat and are used in close proximity to users' bodies.

One commonly used safety feature in controllers that charge batteries is a so-called “safety timer”. This safety feature involves timing how long the battery has been charged for, and terminating charging, if the battery is still being charged after a predetermined time period.

An issue with the conventional “safety timer” feature is that there may be a fault in the system (e.g. in the battery) at the beginning of the charge cycle but the safety timer can allow the charge controller to charge the battery until the end of the predetermined time period. The predetermined time period after which charge will be terminated may be fixed at up to ten hours, for example. Thus, if the battery is defective at the beginning of a charge cycle, the battery may be allowed to continue to charge for the full ten hours, which might lead to catastrophic failure of the aerosol generating device.

Thus, it would be desirable to provide more sophisticated charging safety features, which can assist in avoiding catastrophic failures while charging a battery in an aerosol-generating system.

It would further be desirable to provide a charging method that may assist in detecting charging issues at early stages during the charging process.

According to an embodiment of the invention there is provided a method for charging a battery in an aerosol-generating system. The method comprises the steps of:
initiating charging of the battery;
monitoring an electrical parameter indicative of a charging rate of the battery;
determining the charging rate of the battery;
comparing the determined charging rate to a reference charging rate; and
if the charging rate deviates from the reference charging rate, inhibiting the battery from being charged.

According to an embodiment of the invention there is provided a method for charging a battery in an aerosol-generating system, the method comprising:
initiating charging of the battery;
monitoring an electrical parameter indicative of a charging rate of the battery;
determining the charging rate of the battery by monitoring the change of the electrical parameter over a given time period; and
comparing the determined charging rate to a reference charging rate, wherein the reference charging rate is defined by a change in the monitored electrical parameter
if the charging rate deviates from the reference charging rate, inhibiting the battery from being charged.

By determining the charging rate during the charging process, anomalous charging can be detected early. Thus, with the method of the present invention, the charging process can be interrupted, stopped completely, or reduced to a safe level upon detection of critical charging rates. In this way, the present invention allows to avoid prolonged charging of defective batteries. Thereby the invention helps to reduce potentially hazardous situations in relation to charging batteries used in aerosol-generating systems.

The power supply may be a Nickel-metal hydride battery, a Nickel cadmium battery, or a Lithium-Ion battery, for example a Lithium-Cobalt-Oxide (LCO), a Lithium-Iron-Phosphate (LFP), a Lithium-Nickel-Manganese-Cobalt-Oxide (NMC), a Lithium-Nickel-Cobalt-Aluminium-Oxide (NCA), Lithium Titanate (LTO) or a Lithium-Polymer (LiPo) battery. The power supply may require recharging and may have a capacity that enables to store enough energy for one or more usage experiences; for example, the power supply may have sufficient capacity to continuously generate aerosol for a period of around four to ten minutes, or around six minutes, or for multiple periods of around four to ten minutes, or for multiple periods of around six minutes. In another example, the power supply may have sufficient capacity to provide a predetermined number of puffs or discrete activations of the heating element.

The reference charging rate may be an expected charging rate. The charging process for charging the re-chargeable battery may comprise different charging modes. The charging modes may differ in the way electrical power is provided to the battery.

In embodiments the charging modes of a charging process may comprise a pre-charge mode, a current regulation mode and a voltage regulation mode.

In the pre-charge mode, a first constant current (for instance, called the “pre-charge current”) may be applied. This pre-charge current may be applied until the voltage output of the battery reaches a pre-charge voltage threshold.

In the constant current regulation mode, a second constant current (for instance, called the “regulation current”) may be applied. The regulation current applied in the constant-current mode may be larger than the pre-charge current, which is applied in the pre-charge mode. The regulation current may be applied until the voltage output of the battery reaches the regulation voltage threshold. Thus, the constant current regulation mode may be used whenever the voltage output of the battery is in the range between the pre-charge voltage threshold and the regulation voltage threshold.

After the pre-charge mode and the constant current regulation mode are complete, the constant voltage regulation mode may be used. In this mode, a constant voltage (for instance called the “regulation voltage”) may be applied to the battery, while the charging current successively decreases. The regulation voltage may be applied until the charging current falls to a charge termination current level. When the charge current reaches the charge termination current level, this indicates that the battery has reached its desired state of charge. Once this desired state of charge is reached, the battery may be considered to be fully charged and charging may be stopped.

The parameter, or parameters, indicative of the charging rate of the battery to be monitored, and the reference charging rate, may be selected depending on the charge mode applied. The parameter, or parameters, indicative of the charging rate may be the output voltage of the battery and/or the current drawn by the battery while it is being charged. The charging rate may be determined from the monitored electrical parameter.

In those charging modes in which a constant current is applied, in other words in the pre-charge mode and in the constant current regulation mode, the parameter indicative of the charging rate may be the output voltage of the battery that is to be charged. Over large ranges of these charging modes the output voltage of the battery increases generally linearly over time. Increase of the output voltage lowers towards the end of the constant current regulation mode when the output voltage approaches the regulation voltage threshold.

In the voltage regulation mode, a constant voltage is applied. In this charging mode the parameter indicative of the charging rate may be the current drawn by the battery that is to be charged. In the voltage regulation mode, the current drawn may decrease exponentially over time.

The charging rate may be determined by any suitable method known to the skilled person. In order to determine the charging rate, an electrical parameter indicative of the charging rate of the battery may be monitored. In embodiments, the charging rate of the battery may be obtained by monitoring the change of the electrical parameter over a given time period. In one illustrative example, the change of the electrical parameter might be zero; in other words, monitoring the change of the electrical parameter may comprise observing that no change of the electrical parameter has occurred. This might indicate a fault, and thus charging can be inhibited accordingly. Monitoring the electrical parameter may comprise determining the electrical parameter at a first time and determining the electrical parameter at a second time. In one example, the parameter indicative of the charging rate is the power or energy supplied to the battery while charging, or the state of charge of the battery. The power or energy supplied to the battery while charging can be monitored over time and therefore the charging rate of the battery can be determined. A high power or energy supplied to the battery over a time interval is indicative of a high charging rate, while a low power or energy supplied to the battery over the time interval is indicative of a low charging rate. In addition or alternatively, the state of charge of the battery can be monitored over time and therefore the charging rate can be determined. A faster increase in the state of charge of the battery over a time interval is indicative of a higher charging rate, while a slower increase in the state of charge of the battery over the time interval is indicative of a lower charging rate.

The difference of the values of the electrical parameter determined at the two times may be divided by the time difference between the two different times. The resulting ratio of the difference of the two values of the electrical parameter and the time difference may be indicative of the currently applied charging rate.

The electrical parameter may be monitored at regular time intervals. The time intervals may be adapted to the type of battery to be charged. The time intervals may be adapted to the type of power source used for charging the battery. The time intervals may be adapted to a predetermined charging scheme that is to be applied for charging the battery.

The electrical parameter may be monitored at every second. The electrical parameter may be monitored at every ten seconds. The electrical parameter may be monitored at every twenty seconds. The electrical parameter may be monitored at every minute, every five minutes, every ten minutes, every half-hour, every hour, or every 2 hours. Preferably, the time interval between each monitoring of the electrical parameter is less than the expected maximum time for which the battery should be charged.

The method may include determining the charging rate by monitoring the state of charge of the battery, by monitoring the output voltage of the battery or by monitoring the charging current applied to charge the battery.

The method may include determining the charging rate by monitoring a plurality of electrical parameters indicative of the charging rate of the battery.

The method may include determining the charging rate by monitoring the state of charge of the battery and the output voltage of the battery. The method may include determining the charging rate by monitoring the state of charge of the battery and the charging current applied to charge the battery. The method may include determining the charging rate by monitoring the output voltage of the battery and the charging current applied to charge the battery. The method may include determining the charging rate by monitoring the state of charge of the battery, the output voltage of the battery and the charging current applied to charge the battery. Which or which combination of those parameters indicative of the charging rate of the battery is used at a given time, may be selected depending on the current charge mode applied.

The charging rate of the battery may be determined by monitoring the change of the electrical parameter over a given time period. Monitoring the electrical parameter may comprise determining the electrical parameter at a first time and determining the electrical parameter at a second time. The difference of the values of the electrical parameter determined at the two times may be divided by the time difference between the two different times. The resulting ratio of the difference of the two values of the electrical parameter and the time difference may be indicative of the currently applied charging rate. If the parameters are monitored at regular intervals, then the difference of consecutively determined values of the electrical parameter may be used as a measure for the charging rate.

The expected change of the monitored electrical parameter may depend on the duration of the measurement interval. The shorter the interval, the smaller the expected change of the monitored electrical parameter.

The currently applied charging rate determined as described above may then be compared to the reference charging rate. The reference charging rate may be determined from a charging scheme stored in a data storage unit of the aerosol-generating system. The reference charging rate may be determined from an average of previous charging processes. Previous charging processes may also be used to modify a stored standard charging scheme. By taking into account previous charging processes for a given battery, the reference charging rate may be customized to better approximate the charging process for a given battery.

The reference charging rate may be defined by a change in the monitored electrical parameter. For instance, the reference charging rate may be defined by a change in the voltage output of the battery, or the reference charging rate may be defined by a change in the current applied to charge the battery. Then, the actual charging rate of the battery may be determined by measuring the electrical parameter (e.g. the voltage output of the battery, or the current applied to charge the battery) at two or more points in time and calculating the change in the electrical parameter. If the calculated change in the measured electrical parameter deviates from the change in the electrical parameter defined by the reference charging rate, then charging may be inhibited. For instance, if the calculated change in the measured electrical parameter is lower than the change in the electrical parameter defined by the reference charging rate, this might be indicative of a fault in the charging system. Therefore, the charging can be inhibited, or prevented. In one illustrative example, there may be no change in the electrical parameter observed, and the reference charging rate may be defined as a non-zero change in the electrical parameter. In this case, the change in the electrical parameter would be less than the reference charging rate, and thus charging can be inhibited accordingly.

The reference charging rate may be defined by mathematical means. The reference charging rate may be defined by means of a linear or non-linear relationship between the parameter that is indicative of the charging rate and time.

For example, during the pre-charge mode a relatively linear relationship is expected between the battery voltage and charging time. Accordingly, the following linear equation may be used to define the relationship between the battery voltage and the charging time:

$${V}_{b} ( t ) = mt + c \qquad ( 1 )$$

wherein V_{b} is the battery output voltage, t is time, and m and c are coefficients. The value of “m” may for instance depend on the parameters of the system, such as the current flowing to the battery and the temperature of the battery.

In contrast thereto, in the voltage regulation mode the relationship between the charging current and time can be better approximated by a non-linear equation. In particular, in the voltage regulation mode the charge current may be considered to decay exponentially over time. Therefore, it may be more appropriate to estimate the charging current with the following exponential equation:

$${I}_{C} ( t ) = {e}^{- mt} \qquad ( 2 )$$

wherein I_{c} is the charging current, t is time, and m is a coefficient.

In the pre-charge mode, the determination of the reference charging rate may comprise the following steps.

In a first step the output voltage of the battery may be determined. In a further step, the voltage difference (dV) between the predefined pre-charge threshold and the output voltage is determined. In a next step the reference time (dT) is determined, which is expected to be required to charge the battery from the output voltage to the pre-charge threshold voltage. The expected time to reach the pre-charge threshold may be determined by assuming a standard charging process carried out under standard operating circumstances. Such information may be obtained in a separate calibration step for a sample battery upon manufacture. The reference charging rate may then be calculated by dividing dV by dT.

In the constant current charge mode, the determination of the reference charging rate may be carried out in a similar way.

In a first step again the output voltage of the battery may be determined. In a further step, the voltage difference (dV) between the predefined regulation voltage threshold and the output voltage is determined. In a next step the reference time (dT) is determined, which is expected to be required to charge the battery from the output voltage to the regulation voltage threshold. The reference charging rate may then again be calculated by dividing dV by dT.

The reference time dT may be dependent on the current applied to charge the battery. For instance, if the current applied to charge the battery is higher, then the expected time to charge will be lower, and therefore the reference time dT will be lower. On the other hand, if the current applied to charge the battery is lower, then the expected time to charge will be higher, and therefore the reference time dT will be higher.

In the voltage regulation charging mode, the determination of the reference charging rate may comprise the following steps:

In a first step the charging current (I_{RC}) to the battery may be determined. In a further step, the difference (dI) between the charging current (I_{RC}) and a termination current (I_{TC}) may be determined. In a next step the reference time (dT) is determined, which is expected to be required to charge the battery until the charging current (I_{RC}) is equal to the termination current (I_{TC}). The reference charging rate may then be calculated by dividing dI by dT.

The reference time dT may be dependent on the current available to be applied to charge the battery, for instance the current available from the mains (e.g. USB) power supply, or from the battery pack used to charge the battery. For instance, if the current available to charge the battery is higher, then the expected time to charge will be lower, and therefore the reference time dT will be lower. On the other hand, if the current available to charge the battery is lower, then the expected time to charge will be higher, and therefore the reference time dT will be higher.

Charging of the battery may be inhibited, if the charging rate deviates from the reference charging rate by at least a predetermined deviation. The amount of the predetermined deviation may be defined taking into account the circumstances of how the charging rate is determined. In particular it may be taken into account, how precise the charging rate is determined and which typical, and therefore acceptable, variations of the charging rate are expected. The amount of the predetermined deviation may be selected based on the operating environment, e.g. based on a temperature reading from a temperature sensor. The predetermined deviation from the reference charging rate may amount up to 40 percent of the reference charging rate. The predetermined deviation from the reference charging rate may amount up to 25 percent of the reference charging rate. The predetermined deviation from the reference charging rate may amount up to 10 percent of the reference charging rate.

The reference charging rate may be defined as a range of charging rates between a lower charging rate threshold and/or an upper charging rate threshold. The lower charging rate threshold and/or the upper charging rate threshold may be suitably chosen for any given battery and the power source available for charging. A too narrow range may increase sensitivity of the charge controller but may also increase the risk that otherwise acceptable variations in charging rates may erroneously trigger stopping of the charging process. A too broadly defined range of charging rates may reduce sensitivity of the charge controller and may slow down recognition of faulty charging processes.

In the definition of the allowable range of charging rates the lower charging rate threshold and/or the upper charging rate threshold may be determined by multiplying the determined reference charging rate with a scaling factor. The scaling factor for determining the lower charging rate threshold may be defined by (1−X), wherein X may amount up to 0.9, wherein X may amount up to 0.8, wherein X may amount up to 0.6, wherein X may amount up to 0.4, wherein X may amount up to 0.2, and wherein X may amount up to 0.1.

The scaling factor for determining the upper charging rate threshold may be defined by (1+X), wherein X may amount up to 0.9, wherein X may amount up to 0.8, wherein X may amount up to 0.6, wherein X may amount up to 0.4, wherein X may amount up to 0.2, and wherein X may amount up to 0.1.

The parameter X for determining the scaling factor of the lower charging rate threshold may be identical to the parameter X used for determining the upper charging rate threshold. When there is a linear relationship between the monitored parameter and time, it may be advantageous to use a symmetric definition of the lower and the upper charging rate thresholds. In contrast, for a non-linear relationship between the monitored parameter and time, it may be advantageous to use an asymmetric definition of the lower and the upper charging rate thresholds.

In some embodiments it may be sufficient to define only a lower charging rate threshold or only an upper charging rate threshold. In either case, a too slow or a too fast charging may be determined and may be used for the identification of a faulty charging process.

In embodiments in which the reference charging rate is defined by a linear or a non-linear equation, the monitored electrical parameter may be continuously recorded over time. The recorded values may then be approximated by calculating an approximation equation. For instance, in case of an expected linear relationship between the monitored parameter and time according to equation (1) mentioned above, the monitored relationship between the battery voltage and time may be calculated to be best approximated by the following equation:

$${V}_{b} ( t ) = m 1 \cdot t + c 1 \qquad ( 3 )$$

These two functions can then be compared with each other in order to calculate a value defining the similarity between the two functions. One method of defining the similarity between the two functions is to perform a cross-correlation between the two functions. The lower the magnitude of the output of the cross-correlation, the higher the similarity is between the recorded rate of charge and the reference rate of charge. If the measure of difference between recorded rate of charge and the reference rate of charge, exceeds a threshold, then this may be indicative of a fault in the system and charging can be inhibited accordingly.

Defining an upper and a lower charging rate threshold may be a simple and effective mechanism for determining a range of allowable charging rates during charging. This method is particularly effective for charging modes, in which only little changes of the charging rates are expected. However, where the relationship between the monitored electrical parameter and time is non-linear, larger changes of the charging rate are expected throughout a given charging mode. This would mean that the upper and lower charging thresholds would need to be set accordingly to account of the highest and lowest charging rates that might be encountered.

In order to further increase sensitivity of the method, one or more of the charging modes may be subdivided into a plurality of charging segments. The reference charging rates and the upper and lower charging thresholds may be different for each segment of the respective charging mode. For example, a given charging mode may be subdivided into two, three, four or even more charging segments. The idea here is to sub-divide a non-linear charging mode into a plurality of segments, which each follow a linear relationship more closely.

It may be particularly advantageous to sub-divide the charging mode in which the current regulation mode is applied into two or more segments. A first segment may be defined in which a constant and rather high charging rate is expected. A second segment may be defined to encompass the non-linear part of this charging mode. In this way, a higher upper charging rate threshold can be applied in the first segment, in comparison to the upper charging rate threshold used in the second segment. Also, a higher lower charging rate threshold can be applied in the first segment, in comparison to the lower charging rate threshold in the second segment. If only one pair of charging rate thresholds were to be chosen for this charging mode, the lower charging rate threshold for the second segment and the upper charging rate threshold for the first segment might have been chosen for the complete charging mode. This would result in a broad range of allowable charging rates, which would lengthen the time to detect a faulty charging process, and to a later termination of the charging process. Instead, by sub-dividing a mode into a plurality of segments, the sensitivity of the method may be enhanced and faulty charging processes can be detected at an earlier stage.

It may be possible that a breach of one of the charging thresholds might be an anomalous breach. In such case it would not be necessary and it would not be desirable to stop the charging process. Thus, in order to avoid pre-mature termination of the charging process, a plurality of breaches of either charging thresholds may be required. Thus, only upon repeated breach of either of the charging thresholds termination of the charging process is triggered. The required number of breaches may be freely chosen depending on the circumstances of the respective aerosol-generating system. The number of breaches detected that would trigger a termination of the charging process may be for instance five, ten or fifteen breaches. The breaches may also be required to be consecutive or non-consecutive breaches. It may also be possible to use a mixture of consecutive and non-consecutive breaches to define the trigger threshold. For example, charging may be stopped if five consecutive breaches or ten non-consecutive breaches are determined.

According to an embodiment of the invention there is provided an aerosol-generating system comprising a battery and a charge controller. The aerosol-generating system is configured to carry out the charging method as described above. For this purpose, the charge controller is configured to initiate charging of the battery, to monitor an electrical parameter indicative of a charging rate of the battery. The charge controller is further configured to determine the charging rate of the battery and to compare the determined charging rate to an reference charging rate. If the charging rate deviates from the reference charging rate, the charge controller is configured to inhibit the battery from being charged.

The charge controller may be configured to determining the charging rate of the battery by monitoring the change of the electrical parameter over a given time period and to compare the determined charging rate to a reference charging rate, wherein the reference charging rate is defined by a change in the monitored electrical parameter. If the charging rate deviates from the reference charging rate, inhibiting the battery from being charged.

The aerosol-generating system may comprise an aerosol-generating device that interacts with an aerosol-forming substrate to generate an aerosol. The aerosol-generating system may further comprise a charging case. The charging case may be a portable charging case. The charging case may be configured to be connected to the aerosol-generating device for charging purposes.

As used herein, the term “aerosol-generating device” refers to a device that interacts with an aerosol-forming substrate to generate an aerosol. An aerosol-generating device may interact with one or both of an aerosol-generating article comprising an aerosol-forming substrate, and a cartridge comprising an aerosol-forming substrate. In some examples, the aerosol-generating device may heat the aerosol-forming substrate to facilitate release of volatile compounds from the substrate. An electrically operated aerosol-generating device may comprise an atomiser, such as an electric heater, to heat the aerosol-forming substrate to form an aerosol.

According to an embodiment of the invention there is provided an aerosol-generating device for use in an aerosol-generating system. The aerosol-generating device comprises a re-chargeable battery, a first power interface for connecting the re-chargeable battery to an external power source, and a host controller for controlling power supply from the re-chargeable battery to an electric heater. The aerosol-generating device further comprises a charge controller. The charge controller may be comprised in a host controller of the aerosol-generating device. Alternatively, the charge controller may be comprised in a battery charger IC of the aerosol-generating device.

By providing the charge controller in the aerosol-generating device, versatility of the aerosol-generating device with respect to charging is increased. In these embodiments the charging process may be controlled by the circuitry provided within the aerosol-generating device. In order to carry out the charging process it is sufficient to connect the aerosol-generating device to a suitable external power source.

The external power supply may be a mains AC adaptor which receives an AC input from the mains, and outputs a DC voltage suitable for charging the re-chargeable battery. Typically, a DC output of about 5 Volts is provided from the power supply.

The first power interface for connection to the power supply may be any suitable connection means. The connection means may be a USB interface, such as a USB-A or USB-C interface.

The aerosol-generating device may comprise a host microcontroller. The host microcontroller may be configured for executing the required functions of the aerosol-generating device, such as the provision of electrical power to the heater from the battery so that aerosol can be generated from an aerosol generating substrate. The host microcontroller may be further configured to comprise the charge controller. Thus, the host microcontroller may also be configured for executing and controlling the charging process of the re-chargeable battery of the aerosol-generating device.

The aerosol-generating device may also comprise a separate battery charger IC. If a battery charger IC is provided, the battery charger IC may be configured for executing and controlling the charging process of the re-chargeable battery of the aerosol-generating device.

The re-chargeable battery of the aerosol-generating device provides power to the host microcontroller and to the heater, so that the aerosol-generating device can be used when it is no longer connected to the power supply.

According to an embodiment of the invention there is provided a charging case for an aerosol generating device as described above. The charging case may comprise a re-chargeable battery, a first power interface for connecting the re-chargeable battery of the charging case to an external power supply. The charging case may comprise a second power interface for connecting the re-chargeable battery of the charging case to a re-chargeable battery of the aerosol generating device. The charging case may further comprise a charge controller for charging the rechargeable battery of the aerosol-generating device.

By providing the charge controller in the charging case, it is not necessary anymore to provide a charge controller in the aerosol-generating device. Thus less electronic circuitry is required in the aerosol-generating device. This may reduce manufacturing complexity of the aerosol-generating device. At the same time cost efficiency of the manufacturing process of the aerosol-generating device may be increased.

Again, the external power supply may be a mains AC adaptor which receives an AC input from the mains, and outputs a DC voltage. The first power interface for connecting the charging case to the power supply may be any suitable connection means. The connection means may be a USB interface, such as a USB-A or USB-C interface.

The second power for connecting the re-chargeable battery of the charging case to a re-chargeable battery of the aerosol generating device may also be any suitable connection means, and may again be a USB interface.

According to an embodiment of the invention there is provided a charging case for an aerosol generating device as described above. The charging case may comprise a re-chargeable battery, a first power interface for connecting the re-chargeable battery of the charging case to an external power supply. The charging case may comprise a second power interface for connecting the re-chargeable battery of the charging case to a re-chargeable battery of the aerosol generating device. The charging case may further comprise a host microcontroller comprising the charge controller for charging the re-chargeable battery of the charging case. Alternatively, the charging case may comprise a battery charger IC comprising the charge controller for charging the re-chargeable battery of the charging case.

The host microcontroller of the charging case may be configured for executing the required functions of the charging case. Such functions may include the downloading of data from the aerosol-generating device. The host microcontroller may also be configured for communicating with an external device, such as a computer. The host microcontroller may be configured for executing the transmission of data downloaded from the aerosol-generating device to an external device, such as a computer, via the USB interface.

The invention is defined in the claims. However, below there is provided a non-exhaustive list of non-limiting examples. Any one or more of the features of these examples may be combined with any one or more features of another example, embodiment, or aspect described herein.

Example A: A method for charging a battery in an aerosol-generating system, the method comprising:
initiating charging of the battery;
monitoring an electrical parameter indicative of a charging rate of the battery;
determining the charging rate of the battery;
comparing the determined charging rate to a reference charging rate; and
if the charging rate deviates from the reference charging rate, inhibiting the battery from being charged.

Example A′: A method for charging a battery in an aerosol-generating system, the method comprising:
initiating charging of the battery;
monitoring an electrical parameter indicative of a charging rate of the battery;
determining the charging rate of the battery by monitoring the change of the electrical parameter over a given time period; and
comparing the determined charging rate to a reference charging rate, wherein the reference charging rate is defined by a change in the monitored electrical parameter;
if the charging rate deviates from the reference charging rate, inhibiting the battery from being charged.

Example B: The method according to example A or example A′, wherein a plurality of parameters indicative of the charging rate of the battery are monitored.

Example C: The method according to example A or example A′, wherein the parameters indicative of the charging rate are the state of charge of the battery and the output voltage of the battery.

Example D: The method according to example A or example A′, wherein the parameters indicative of the charging rate are the state of charge of the battery and the charging current applied to the battery.

Example E: The method according to any preceding example wherein the reference charging rate is an expected charging rate.

Example F: The method according to any preceding example or example B, wherein the battery is a rechargeable lithium-ion battery.

Example G: The method according to any preceding example, wherein charging the battery is inhibited, if the charging rate deviates from the reference charging rate by at least a predetermined deviation.

Example H: The method according to any preceding example, wherein the charging process comprises different charging modes.

Example I: The method according to any preceding example, wherein the charging process comprises a pre-charge mode, a current regulation mode and a voltage regulation mode.

Example J: The method according to any preceding example, wherein the parameter indicative of the charging rate of the battery to be monitored is selected depending on the charge mode applied.

Example K: The method according to any preceding example, wherein the parameter indicative of the charging rate is the output voltage of the battery, the current applied to the battery, the energy supplied to the battery, the power supplied to the battery, or the state of charge of the battery.

Example L: The method according to any preceding example, wherein monitoring the electrical parameter comprises determining an electrical parameter at a first time and determining the electrical parameter at a second time.

Example M: The method according to example L, wherein determining the charging rate of the battery comprises calculating a ratio of a change of the electrical parameter determined at the first time and the second time, and the time difference between the first time and the second time.

Example N: The method according to any preceding example, wherein the reference charging rate is determined from a charging scheme stored in a data storage unit of the aerosol-generating system.

Example O: The method according to any preceding example wherein the reference charging rate is defined as a change in the monitored electrical parameter.

Example P: The method according to any preceding example wherein determining the charging rate comprises monitoring a change in the electrical parameter between a first time and a second time.

Example Q: The method according to any one of example O and example P, wherein the method further comprises determining that the charging rate deviates from the reference charging rate by determining that the monitored change in the electrical parameter is less than the change in the monitored electrical parameter defined by the reference charging rate.

Example R: The method according to any preceding example, wherein in the pre-charge mode and/or in the current regulation charge mode, determining the reference charging rate comprises the steps of:
determining the output voltage of the battery
determining the difference dV between the output voltage and a predefined threshold voltage for the respective charge mode,
determining the reference time dT to charge the battery from the output voltage to the threshold voltage,
calculating the reference charging rate by dividing dV by dT.

Example S: The method according to example R, wherein the reference time dT is dependent on current applied to charge the battery.

Example T: The method according to any preceding example, wherein in the voltage regulation charge mode, determining the reference charging rate comprises the steps of:
determining the charging current IRC to the battery,
determining the difference dI between the charging current IRC and a termination current ITC,
determining the reference time dT to charge the battery until the charging current is equal to the termination current,
calculating the reference charging rate by dividing dI by dT.

Example U: The method according to example T, wherein the reference time dT is dependent on the current available to charge the battery.

Example V: The method according to any preceding example, wherein the reference charging rate is defined as a range of charging rates between a lower charging rate threshold and/or an upper charging rate threshold.

Example W: The method according to example V, wherein the lower charging rate threshold and the upper charging rate threshold are determined from multiplying the determined reference charging rate with a scaling factor.

Example X: The method according to example W, wherein the scaling factor for determining the lower charging rate threshold is defined (1−X) and wherein the scaling factor for determining the upper charging rate threshold is defined (1+X), and wherein X may amount up to 0.9, wherein X may amount up to 0.8, wherein X may amount up to 0.6, wherein X may amount up to 0.4, wherein X may amount up to 0.2, and wherein X may amount up to 0.1.

Example Y: The method according to example X, wherein the parameter X for determining the scaling factor of the lower charging rate threshold and the upper charging rate threshold is the same.

Example Z: The method according to any preceding example, wherein a charging mode is split up into a plurality of segments, and wherein the reference charging rate and the upper and lower charging thresholds are different for each segment of the respective charging mode.

Example ZA: The method according to any preceding example, wherein the reference charging rate is defined by means of a linear or non-linear relationship between a parameter that is indicative of the charging rate and time.

Example ZB: The method according to example ZA, wherein successively monitored values of the electrical parameter indicative of a charging rate of the battery are recorded and wherein these recorded values are compared with the reference charging rates according to the linear or non-linear relationship between the parameter that is indicative of the charging rate and time.

Example ZC: The method according to any preceding example, wherein charging is inhibited only after the charging rate has been found to deviate from the reference charging rate for at least a predefined number of times.

Example ZD: The method according to example ZC, wherein charging is inhibited only after the charging rate has been found to deviate from the reference charging rate for at least 5 times, for at least 10 times or for at least 15 times.

Example ZE: A charge controller for an aerosol generating system, the charge controller being configured to:
initiate charging of a battery;
monitor an electrical parameter indicative of a charging rate of the battery;
determine the charging rate of the battery;
compare the determined charging rate to a reference charging rate; and
if the charging rate deviates from the reference charging rate by at least a predetermined deviation, inhibit the battery from being charged.

Example ZE′: A charge controller for an aerosol generating system, the charge controller being configured to:
initiate charging of a battery;
monitor an electrical parameter indicative of a charging rate of the battery;
determine the charging rate of the battery by monitoring the change of the electrical parameter over a given time period;
compare the determined charging rate to a reference charging rate, wherein the reference charging rate is defined by a change in the monitored electrical parameter; and if the charging rate deviates from the reference charging rate by at least a predetermined deviation, inhibit the battery from being charged.

Example ZF: An aerosol-generating device comprising a re-chargeable battery, a first power interface for connecting the re-chargeable battery to an external power source, and a host controller for controlling power supply from the re-chargeable battery to an electric heater;
wherein the host controller comprises the charge controller of example ZE or example ZE′ for charging the re-chargeable battery;
or
wherein the aerosol generating device comprises a battery charger IC comprising the charge controller of example ZE or example ZE′ for charging the re-chargeable battery.

Example ZG: A charging case for an aerosol generating device comprising a re-chargeable battery, a first power interface for connecting the re-chargeable battery of the charging case to an external power supply; and a second power interface for connecting the re-chargeable battery of the charging case to a re-chargeable battery of the aerosol generating device;
wherein the charging case further comprises the charge controller of example ZE or example ZE′ for charging the re-chargeable battery of the aerosol generating device.

Example ZH: A charging case for an aerosol generating device comprising a re-chargeable battery, a first power interface for connecting the rechargeable battery of the charging case to an external power supply; and a second power interface for connecting the re-chargeable battery of the charging case to a re-chargeable battery of the aerosol generating device;
wherein the charging case further comprises a host microcontroller comprising the charge controller of example ZE or example ZE′ for charging the re-chargeable battery of the charging case;
or
wherein the charging case comprises a battery charger IC comprising the charge controller of example ZE or example ZE′ for charging the re-chargeable battery of the charging case.

Features described in relation to one embodiment may equally be applied to other embodiments.

Examples will now be further described with reference to the accompanying drawings in which:

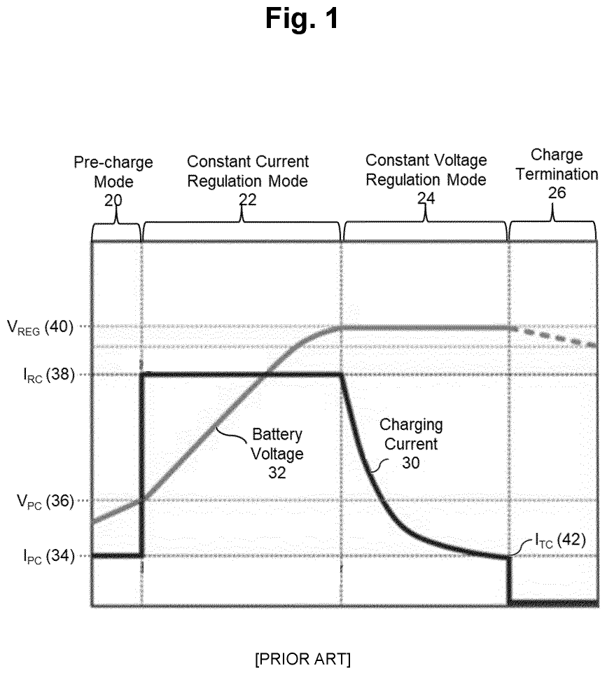

FIG. 1 shows a typical prior art charging process;

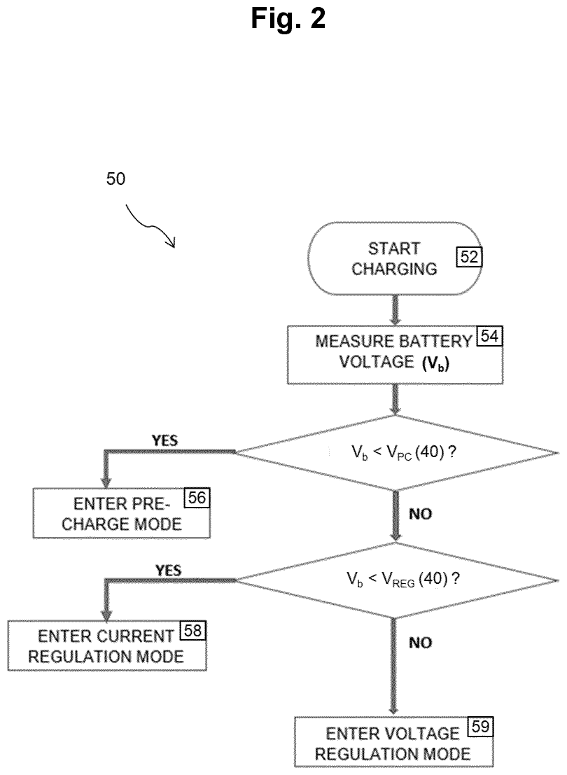

FIG. 2 shows a first stage of a charging method;

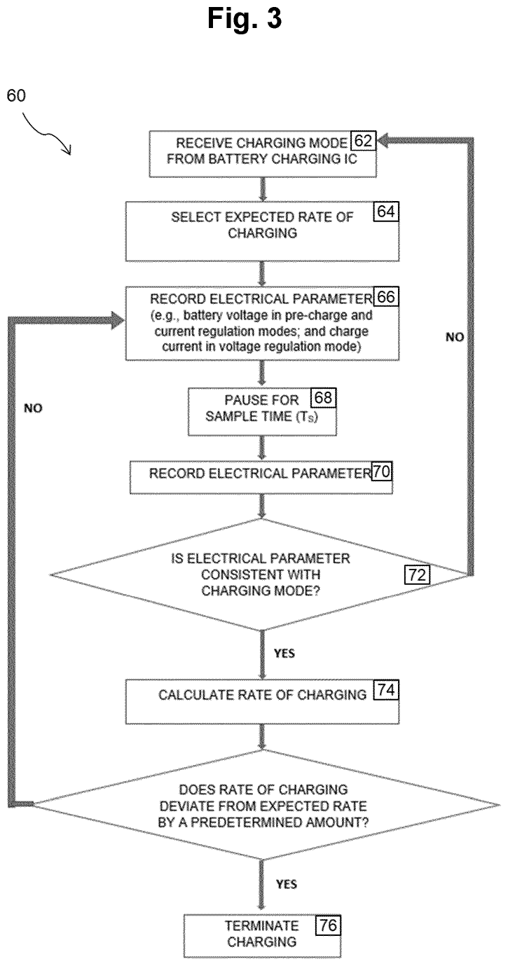

FIG. 3 shows a second stage of the charging method;

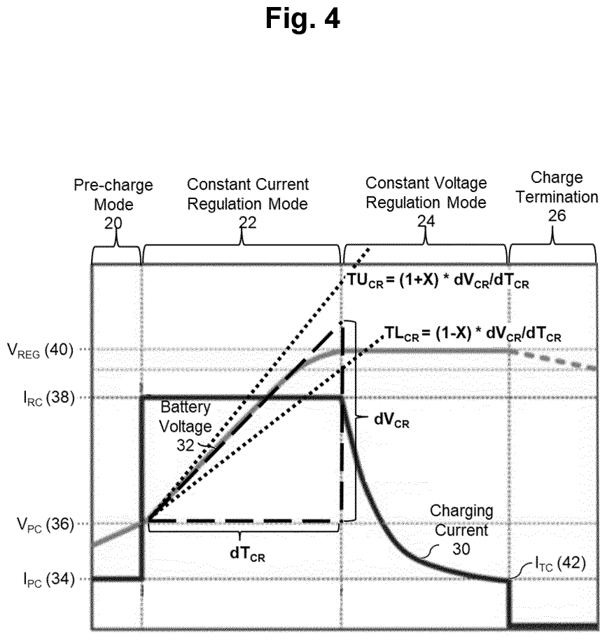

FIG. 4 illustrates the determination of allowable charging rate range in constant current regulation mode;

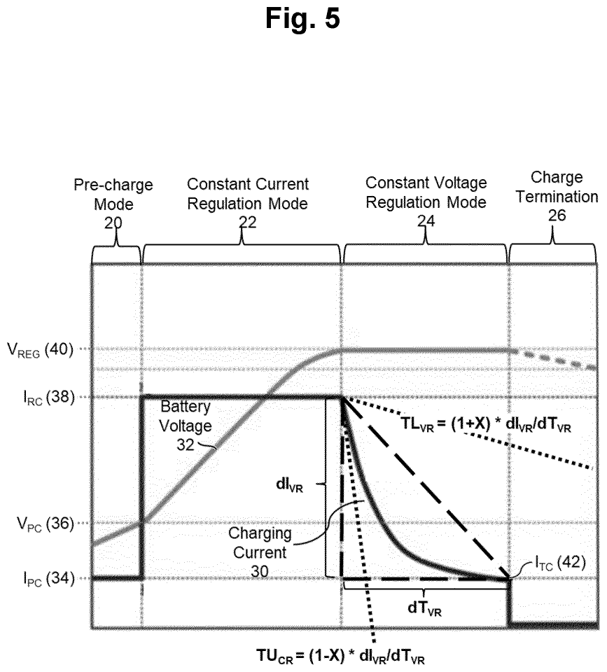

FIG. 5 illustrates the determination of allowable charging rate range in constant voltage regulation mode;

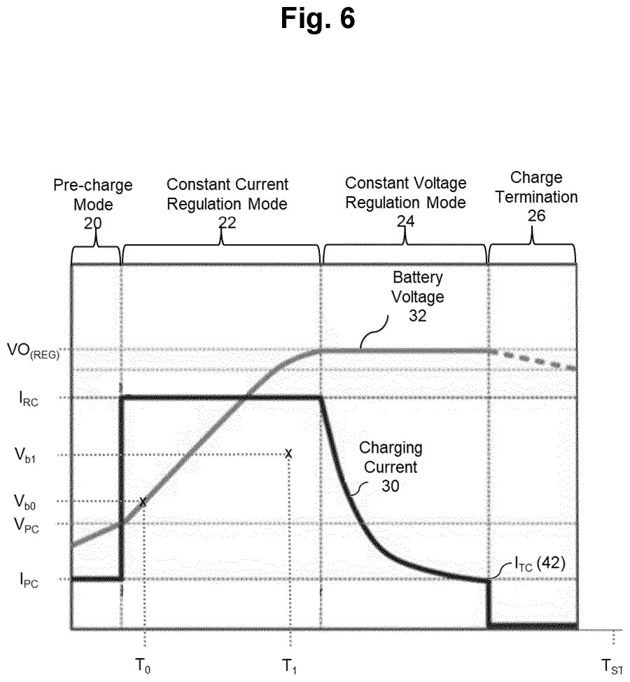

FIG. 6 illustrates the timing advantage of the method;

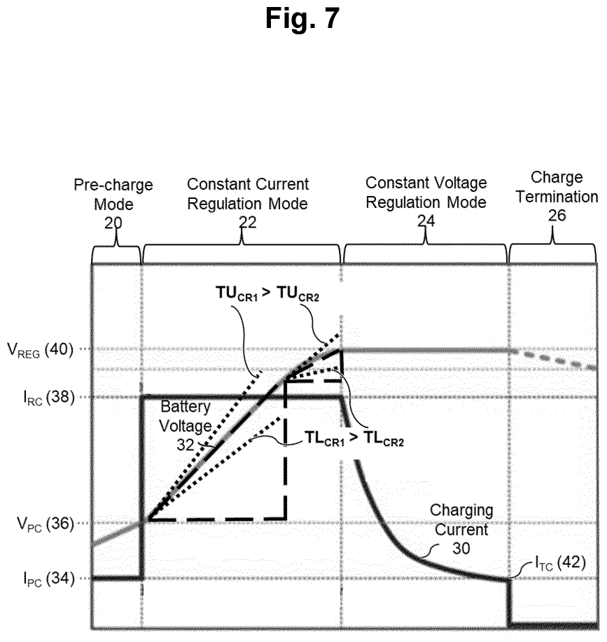

FIG. 7 illustrates a modification of the charging method;

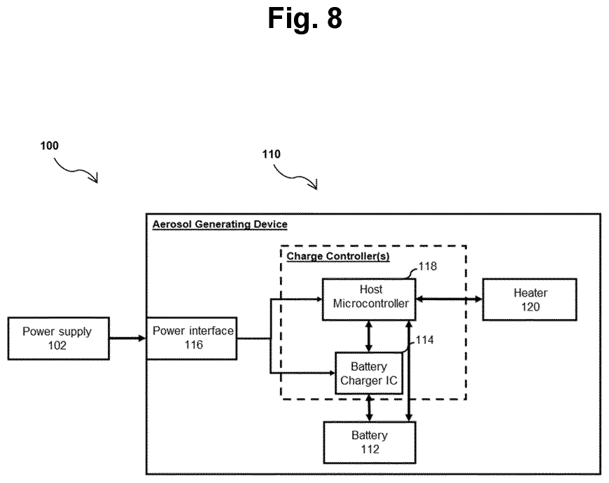

FIG. 8 shows a set-up of an aerosol-generating system;

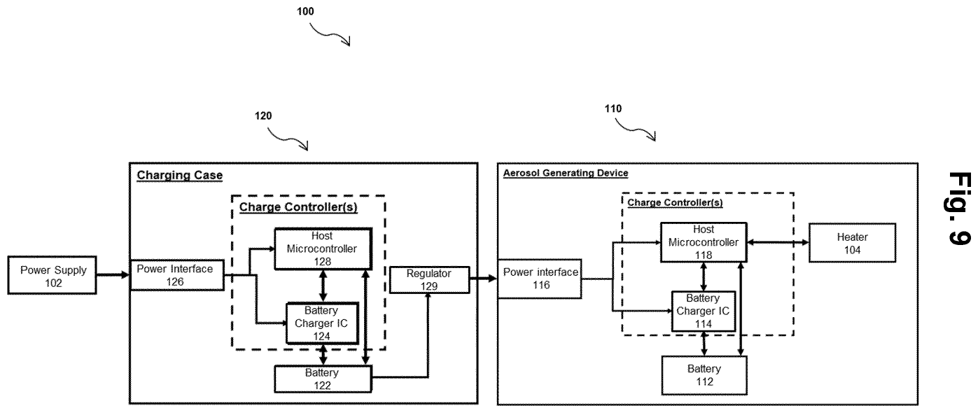

FIG. 9 shows an aerosol-generating system including a charging case;

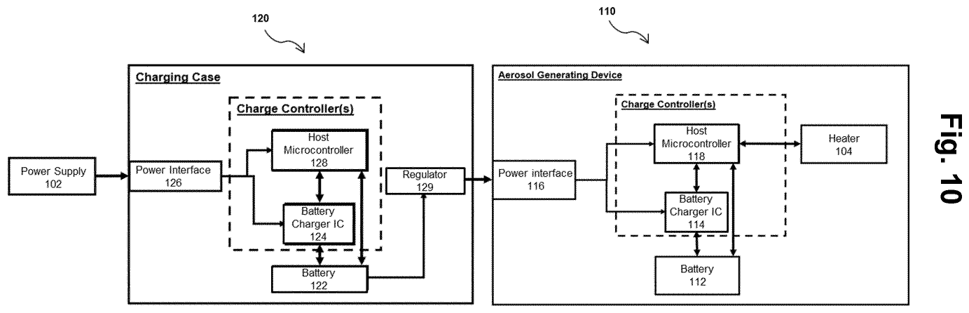

FIG. 10 shows modification of the aerosol-generating system of FIG. 9.

In FIG. 1 a typical charging process 10 for a lithium-ion battery is depicted. The charging process essentially comprises three different charging modes. These charging modes are referred to as the pre-charge mode 20, the constant current regulation mode 22 and the constant voltage regulation mode 24. In a final stage that is referred to in FIG. 1 as charge termination 26 charging of the re-chargeable battery is terminated.

In FIG. 1 the charging current 30 is drawn as the dark grey line and the battery voltage 32 is drawn as a light grey solid line. Assuming a charging process 10 for a rather depleted battery, the charging process 10 starts with the pre-charge mode 20.

In the pre-charge mode 20, a first constant current, called the “pre-charge current” (I_{PC}), 34 is applied. The pre-charge current (I_{PC}) may be around 5 mA or higher. In one example, the pre-charge current (I_{PC}) may be around 10% of the current applied in the constant current regulation mode. This pre-charge current 34 is applied until the battery voltage 32 reaches the pre-charge voltage threshold (V_{PC}) 36. The pre-charge voltage threshold (V_{PC}) may be between around 2V and 4V, between around 2.5V and 3V, around 3V, or around 2V or less. In the following charging mode, the constant current regulation mode 22, a second constant current, called the “regulation current” (I_{RC}), 38 is applied. The regulation current (I_{RC}) may be between around 50 mA and 4 A. In this charging mode, the battery voltage 32 initially increases almost linearly. When the battery voltage 32 approaches the regulation voltage (V_{Reg}) 40, increase of the battery voltage 32 slows down. The regulation voltage may be between around 3V and 4.5V. In particular, the regulation voltage may be around 3.6V-3.7V where the battery comprises Lithium Iron Phosphate. The regulation voltage may be around 4V-4.5V where the battery comprises Lithium Cobalt Oxide (LCO), Lithium Nickel Manganese Cobalt Oxide (NMC), or Lithium Nickel Cobalt Aluminum Oxide (NCA).

Once the regulation voltage (V_{Reg}) 40 is reached, the constant voltage regulation mode 24 is used. In this mode a constant voltage corresponding to the regulation voltage (V_{Reg}) 40 is applied to the battery, while the charging current 30 successively decreases. The regulation voltage (V_{Reg}) 40 is applied until the charging current 30 falls to a predefined level corresponding to a charge termination current (I_{TC}) 42. In the graph of FIG. 1 the level of the charge termination current (I_{TC}) 42 corresponds to the level of the pre-charge current (I_{PC}) 34. However, the charge termination current (I_{TC}) 42 may be less than the pre-charge current (I_{PC}) 34, or the charge termination current (I_{TC}) 42 may be greater than the pre-charge current (I_{PC}) 34.

When the charging current 30 reaches the charge termination current (I_{TC}) 42, the battery is considered to have reached its desired state of charge and charging is stopped.

The prior art charging process 10 depicted in FIG. 1 typically lasts several hours or minutes. In conventionally charging systems a timing safety feature is used. According to this safety feature charging is terminated after a predetermined amount of time, independent of the charging state of the battery. Thereby it is prevented that defective batteries, which may never reach their desired state of charge (SoC), are charged continuously. This safety feature reduces the risk of catastrophic failure during charging.

The charging method aims at identifying charging issues already at an earlier stage, and to terminate charging once such issue is detected.

The method is graphically illustrated by the flowcharts of FIGS. 2 and 3. This method is carried out in an aerosol-generating system comprising a host microcontroller and a battery charging IC. A first stage 50 of the method is illustrated in the flowchart of FIG. 2. In this stage the charge controller determines which charging mode is to be applied. After initiation 52 of the charging process, the charge controller determines the output voltage (V_{b}) of the battery in step 54.

If the output voltage (V_{b}) is below the pre-charge threshold voltage (V_{PC}) the pre-charge mode is entered at step 56.

If the output voltage (V_{b}) is above the pre-charge threshold voltage (V_{PC}), but below the regulation voltage (V_{REG}) the constant current regulation mode is entered at step 58.

If the output voltage (V_{b}) corresponds to or is larger than the regulation voltage V_{REG} the voltage current regulation mode is entered at step 59.

Once the selection of the charging mode in the first stage 50 is finished, the charging process is continued in a second stage 60 as indicated in FIG. 3. In the second stage 60 the battery charger IC communicates the selected charging mode to the host microcontroller (step 62). Then, the host microcontroller selects a reference (or “expected”) rate of charging based on the determined charging mode as depicted in step 64 in the flowchart of FIG. 3.

In the example of FIGS. 2 and 3, for each charging mode upper and lower charging rate thresholds are stored in the host microcontroller's memory. In step 64 these stored charging thresholds for the selected charging mode are read from the host microcontroller's memory. Thus, in this example the expected charging rate is defined as a range of charging rates.

After the host microcontroller has selected the expected charging rate for the given charging mode, the host microcontroller monitors the rate at which the battery is being charged at regular sampling intervals. This is done by monitoring an electrical parameter indicative of the charging rate. Depending on the charge mode, this parameter may be the amplitude of the change in the battery voltage or the change of charging current over the sampling time. The respective monitored electrical parameter is measured at a first time in method step 66. After a pause for the sampling time (step 68), the monitored electrical parameter is measured at a second time in method step 70. After a confirmation that the monitored electrical parameter is still consistent with the selected charging mode (step 72), the charging rate is calculated based on these two measurements for the electrical parameter in step 74. The charging rate is calculated as the ratio of the difference between the two values of the electrical parameter measured at the first and at the second time, and the sample time dT between these two measurements.

In the example of FIGS. 2 and 3 where upper and lower thresholds define the expected charging rate, if the amplitude of the change breaches either the upper or lower threshold, then charging will be terminated in method step 76.

If the determined charging rate is within the expected charging range, charging will be allowed to continue. For this purpose the method will continue at step 66 by again determining the charging rate.

In one example, expected rates of charging and sample times (Ts) may be predefined and stored in memory, each in association with a particular charging mode. For example, the pre-charge mode might be expected to finish after an absolute maximum time of 1 hour (assuming charging conditions that would result in a slow charging rate, e.g. low charging current, low temperature, and high battery capacity). In addition, the maximum change in the battery output voltage might be expected to be the pre-charge voltage threshold (V_{PC}) minus the lowest reasonable voltage output for the battery, e.g. 3V−2V=1V. Therefore, the predefined expected charging rate stored in the memory for the pre-charge mode might be a 1V increase in the battery output voltage after 1 hour. Thus, the expected charging rate might be defined as a difference in the voltage output of the battery, e.g. 1V, and the sample time (Ts) might be set at 1 hour. Then, if the voltage output of the battery has not increased by a value less than 1V in 1 hour, the controller can detect that there is an issue in the system, and charging can be prevented, or inhibited.

The constant current regulation mode might be expected to finish after an absolute maximum time of 3 hours (again, assuming charging conditions that would result in a slow charging rate, e.g. low charging current, low temperature, and high battery capacity). In addition, the maximum change in the battery output voltage might be expected to be regulation voltage (V_{Reg}) minus the pre-charge voltage threshold (V_{PC}), e.g. 4.2V−3V=1.2V. Therefore, the predefined expected charging rate stored in the memory for the pre-charge mode might be a 1.2V increase in the battery output voltage after 3 hours. Thus, the expected charging rate might be defined as a difference in the voltage output of the battery, e.g. 1.2V, and the sample time (Ts) might be set at 3 hours. Then, if the voltage output of the battery has not increased by a value less than 1.2V in 3 hours, the controller can detect that there is an issue in the system, and charging can be prevented, or inhibited.

The constant voltage regulation mode might be expected to finish after an absolute maximum time of 2 hours (again, assuming charging conditions that would result in a slow charging rate, e.g. low available charging current, low temperature, and high battery capacity). In addition, the maximum change in the current applied to charge the battery might be expected to be the regulation current (I_{RC}) minus the pre-charge current (I_{PC}), e.g. 2 A−0.2 A=1.8 A. Therefore, the predefined expected charging rate stored in the memory for the pre-charge mode might be a 1.8 A decrease in the current applied to charge the battery after 2 hours. Thus, the expected charging rate might be defined as a difference in the current applied to charge the battery, e.g. 1.8 A, and the sample time (Ts) might be set at 2 hours. Then, if the current applied to charge the battery has not decreased by a value less than 1.8 A in 2 hours, the controller can detect that there is an issue in the system, and charging can be prevented, or inhibited.

In another example, the allowable range of expected charging rates may also be defined as illustrated in FIGS. 4 and 5.

For the constant current regulation mode 22, the upper charging-rate threshold (TU_{CR}) and the lower charging-rate threshold (TL_{CR}) are set by the following method.

For a given output voltage (V_{b}), in a first step the difference (dV_{CR}) between the given battery voltage (V_{b}) and the regulation voltage threshold (V_{(Reg)}) is determined. The difference (dV_{CR}) may be very low for instance when charging is approaching the end of the constant current regulation mode. In this case, the difference (dV_{CR}) may be around 0.1V or higher. The difference (dV_{CR}) may be high for instance when charging is towards the beginning of the constant current regulation mode. In this case, the difference (dV_{CR}) may be around the difference between V_{REG} and V_{PC}, e.g. around 2.5V.

In a next step the expected time (dT_{CR}) that is required to charge the battery from the given output voltage (V_{b}) to the regulation voltage (V_{Reg}) is determined. The expected time (dT_{CR}) may be very low for instance when charging is approaching the end of the constant current regulation mode. In this case, the difference (dT_{CR}) may be around 10 seconds or higher. The expected time (dT_{CR}) may be high for instance when charging is towards the beginning of the constant current regulation mode. In this case, the expected time (dT_{CR}) may be around 5 hours. The expected time (dT_{CR}) will vary depending on the rated capacity of the battery since higher capacity batteries will take more time to charge, and lower capacity batteries will take less time to charge.

The expected average charging rate is then calculated as the ratio of dV_{CR} and dT_{CR}. This ratio provides the normal rate of change of battery voltage 32 with respect to time in the current regulation mode 22. The upper charging rate threshold (TU_{CR}) and lower charging rate threshold (TL_{CR}) for the constant current regulation mode 22 is calculated by multiplying dV_{CR}/dT_{CR} with a scaling factor (1.0+X) and (1.0−X), respectively. In this case X is set to be identical and about 0.15 for both, the upper and the lower charging rate threshold (TU_{CR} and TL_{CR}). The expected average charging rate and the charging rate thresholds are indicated with the dashed and dotted lines in FIG. 4. The dashed line illustrates the expected average charge rate in the current regulation mode 22. The dotted lines illustrate the upper and the lower charge rate thresholds (TU_{CR}, TL_{CR}) for the current regulation mode 22, respectively.

For the constant voltage regulation mode 24, the upper and lower charging-rate thresholds may be set by the following method.

In a first step the expected time (dT_{VR}) is determined, which is required to charge the battery from the point where the charging current is equal to the regulation current (I_{RC}) to the point where the charging current is equal to the termination current I_{TC}.

In a next step, the difference (dI_{VR}) between I_{RC} and I_{TC}, giving dI_{VR} is determined. As mentioned previously, I_{TC} may be around 10% of I_{RC}. Therefore, dI_{VR} may be around 0.9×I_{RC}. For instance, if I_{RC} is 2 A then dI_{VR} may be 1.8 A.

The expected average charging rate is then calculated as the ratio of dI_{VR} and dT_{VR}. This ratio provides the normal rate of change of charge current with respect to time in the voltage regulation mode. The upper and lower charging rate thresholds for the constant voltage regulation mode is calculated by multiplying dI_{VR}/dT_{VR} by a scaling factor (1.0+X) and (1.0−X), respectively. In this case X is set to be identical and about 0.15 for both, the upper and the lower threshold. These charging thresholds are indicated in FIG. 5. The dotted line illustrates the normal charge rate in the voltage regulation mode. The solid line illustrates the upper charge rate threshold for the voltage regulation mode. The point solid line illustrates the lower charge rate threshold for the voltage regulation mode.

The scaling factor can be chosen to account for the non-linear relationship between the charge current with respect to time. In the voltage regulation mode, X can be chosen so that TU_{VR} is higher than the normal rate of change in the first half on this mode (where the rate is fastest); and Y can be chosen so that TL_{VR} is lower than the expected rate of change in the second half of this mode (where the rate is slowest).

The advantageous effect of the charging method is illustrated by the diagram of FIG. 6. The diagram of FIG. 6 shows a charging process for a lithium-ion battery and illustrates the charging current 30 and the expected battery voltage 32 throughout the charging process 10.

In the example of FIG. 6 the battery voltage V_{b0} is measured at a first time T₀. Based on this measurement the charge controller will select the constant current regulation mode 22 and will apply a constant charging current I_{RC} to the battery. The charge controller may then measure at a second time T₁ the battery voltage V_{b1}. As can be seen in FIG. 6 the battery voltage V_{b1} at time T₁ is well below the expected battery voltage at that time. For this reason, the host microcontroller determines at the time T₁ that the charging rate is much lower than expected. The charge controller interprets this situation as being indicative of a fault in the system and will inhibit further charging of the battery. Thus, already during charging a potential hazardous situation can be detected and safety measures can be taken.

The conventionally used fixed safety timer approach is only capable of inferring fault and terminating charge after a time period T_{ST} which exceeds the total expected charged time of the battery. Thus, T_{ST} is much greater than the time T₁ at which the method can infer a fault. Accordingly, with the method a fault can be inferred and corrective action can be taken more quickly in comparison to using the conventionally applied fixed safety timer system.

In FIG. 7 a method is depicted that allows reducing the time taken to infer faults in particular during non-linear charging modes. For this purpose a non-linear charging mode is split into a plurality of segments, whereby each segment follows a linear relationship more closely.

In the example of FIG. 7, the current regulation mode is broken up into two segments. The first segment has a higher expected charging rate than the second segment. Therefore, a higher upper charging rate threshold can be applied in the first segment, in comparison to the upper charging rate threshold in the second segment. Also, a higher lower charging rate threshold can be applied in the first segment, in comparison to the lower charging rate threshold in the second segment. If only one pair of charging rate thresholds were to be chosen for the current regulation mode, the lower charging rate threshold for the second segment and the upper charging rate threshold for the first segment might be chosen, since these represent the highest and lowest expected charging rates. However, this would result in a wide band of charging rates that would be allowable. Thus, in order to be identified as an unallowable charging rate, a charging rate would need to deviate strongly from average expected charging rate. This would mean that it will take longer until a fault of the charging process is detected in comparison to breaking the charging mode into segments as shown in FIG. 7.

For carrying out the method, the host microcontroller determines which segment of the mode that charging is currently in by measuring the battery voltage or the charging current. The thresholds can then be determined based on these parameters, for instance by referencing a look up table of voltages/charging currents each associated with an upper and lower charging rate threshold.

The same principle can be applied across the complete charging cycle, and may also be used in the voltage regulation mode and/or in the pre-charge mode.

Three examples of different architectures for an aerosol generating system 100 implementing the method are shown in FIGS. 8 to 10.

In FIG. 8 the aerosol-generating system 100 comprises an aerosol-generating device 110 that can be connected to an external power supply 102 for charging.

In the depicted example, the power supply 102 is a mains AC adaptor which receives an AC input from the mains, and outputs 5V DC via a USB-C cable. The aerosol-generating 110 device comprises a rechargeable lithium-ion battery 112 and a battery charger IC 114 which controls charging of the battery 112. The battery charger IC 114 receives power from the power interface 116 and delivers it to the battery 112 for charging.

The aerosol-generating device 110 further comprises a host microcontroller 118 for executing the required functions of the aerosol-generating device 110, such as the provision of electrical power to the heater 120 from the battery so that aerosol can be generated from an aerosol-forming substrate.

The battery 112 provides power to the host microcontroller 118 and the heater 120 so that the aerosol-generating device 110 can be used when it is no longer connected to the power supply 102.

In the example of FIG. 9 the aerosol-generating system 100 additionally comprises a charging case 120. Power from the external power supply 102 is used to charge a re-chargeable battery 122 in the charging case 120. In turn, the battery 122 of the charging case 120 is used to charge the battery 112 of the aerosol-generating device 110. The aerosol-generating device 110 has essentially the same construction as in the previous example depicted in FIG. 8.

The charging case 120 comprises a battery 122 and a battery charger IC 124 which controls charging of the battery 122 in the charging case 120. The battery charger IC 124 receives power from the power interface 126 and delivers it to the battery 122 for charging. The power interface 126 for connecting the power supply 102 to the charging case 120 and the power interface 116 for connecting the charging case 120 to the aerosol-generating device 110 are identical and are both USB-C type connections.

The charging case 120 also comprises a host microcontroller 128 for executing the required functions of the charging case 120, such as the downloading of data from the aerosol-generating device 110 and the transmission of this data to an external computer via the USB-C interface.

The charging case 120 includes a regulator 129 which receives power from the charging case battery 122, and outputs a predetermined voltage of 5V to the aerosol-generating device 110. As in the example of FIG. 8, the aerosol-generating device 110 comprises a battery 112 and a battery charger IC 114 which controls charging of the battery 112 in the aerosol-generating device 110. The battery charger IC 114 receives power from its power interface 116 and delivers it to the battery 112 for charging.

In the example of FIG. 10 the aerosol-generating system 100 again comprises a charging case 120 and is similar in most respects to the previous example shown in FIG. 9.

However, in this example, the battery charger IC 125 that charges the battery 112 of the aerosol-generating device 110 is located in the charging case 120 rather than in the aerosol-generating device 110 itself. Thus, all electronic control circuitry related to the charging process is located in the charging case 120. In turn, this means that less circuitry is required to be located in the aerosol-generating device 110. This allows to reduce the number of components of the aerosol-generating device 110 such that a less complex and potentially smaller construction of the aerosol-generating device 110 may be envisaged.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±10% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-19. (canceled)

20. A method for charging a rechargeable lithium-ion battery in an aerosol-generating system, the method comprising:
initiating charging of the rechargeable lithium-ion battery;
monitoring an electrical parameter indicative of a charging rate of the rechargeable lithium-ion battery;
determining the charging rate of the rechargeable lithium-ion battery by monitoring a change of the electrical parameter over a given time period; and
comparing the determined charging rate to a reference charging rate, wherein the reference charging rate is defined by an expected change in the monitored electrical parameter; and
if the charging rate deviates from the reference charging rate, inhibiting the rechargeable lithium-ion battery from being charged.

21. The method according to claim 20,
wherein a plurality of parameters indicative of the charging rate of the rechargeable lithium-ion battery are monitored,
wherein the parameters indicative of the charging rate are a state of charge of the rechargeable lithium-ion battery, an output voltage of the rechargeable lithium-ion battery, and a charging current applied to the rechargeable lithium-ion battery,
wherein a process of the charging comprises different charging modes, and
wherein the electrical parameter indicative of the charging rate of the rechargeable lithium-ion battery to be monitored is selected from the plurality of parameters depending on the charge mode applied.

22. The method according to claim 21,
wherein the process of the charging comprises a pre-charge mode, a current regulation mode, and a voltage regulation mode,
wherein in the pre-charge mode and in a constant current regulation mode, the parameter indicative of the charging rate is the output voltage of the rechargeable lithium-ion battery, and
wherein in the voltage regulation mode, the parameter indicative of the charging rate is a current drawn by the rechargeable lithium-ion battery.

23. The method according to claim 20, wherein charging the rechargeable lithium-ion battery is inhibited only after the charging rate has been found to deviate from the reference charging rate for at least a predefined number of times.

24. The method according to claim 20, wherein charging the rechargeable lithium-ion battery is inhibited if the charging rate deviates from the reference charging rate by at least a predetermined deviation.

25. The method according to claim 20, wherein the monitoring the electrical parameter comprises determining an electrical parameter at a first time and determining the electrical parameter at a second time.

26. The method according to claim 25, wherein the determining the charging rate of the rechargeable lithium-ion battery comprises calculating a ratio of a change of the electrical parameter determined at the first time and the second time, and a time difference between the first time and the second time.

27. The method according to claim 20, wherein the reference charging rate is determined from a charging scheme stored in a data storage unit of the aerosol-generating system.

28. The method according to claim 20, wherein the determining the charging rate comprises monitoring a change in the electrical parameter between a first time and a second time.

29. The method according to claim 27, wherein the determining that the charging rate deviates from the reference charging rate comprises determining that the monitored change in the electrical parameter is less than a change in the monitored electrical parameter defined by the reference charging rate.

30. A charge controller for an aerosol generating system, the charge controller being configured to:
initiate charging of a rechargeable lithium-ion battery,
monitor an electrical parameter indicative of a charging rate of the rechargeable lithium-ion battery,
determine the charging rate of the rechargeable lithium-ion battery by monitoring a change of the electrical parameter over a given time period,
compare the determined charging rate to a reference charging rate, wherein the reference charging rate is defined by an expected change in the monitored electrical parameter, and
if the charging rate deviates from the reference charging rate by at least a predetermined deviation, inhibit the rechargeable lithium-ion battery from being charged.

31. An aerosol-generating device, comprising: a rechargeable lithium-ion battery; a first power interface configured to connect the rechargeable battery to an external power source; and a host controller configured to control a power supply from the rechargeable lithium-ion battery to an electric heater, wherein the host controller comprises the charge controller according to claim 30 for charging the rechargeable lithium-ion battery, or wherein the aerosol generating device comprises a battery charger integrated circuit (IC) comprising the charge controller according to claim 30 configured to charge the rechargeable lithium-ion battery.

32. A charging case for an aerosol generating device, comprising: a rechargeable battery; a first power interface configured to connect the rechargeable battery of the charging case to an external power supply; a second power interface configured to connect the rechargeable battery of the charging case to a rechargeable battery of the aerosol generating device; and the charge controller according to claim 30 configured to charge the rechargeable battery of the aerosol generating device.

33. A charging case for an aerosol generating device comprising a rechargeable lithium-ion battery; a first power interface configured to connect the rechargeable battery of the charging case to an external power supply; and a second power interface configured to connect the rechargeable battery of the charging case to a rechargeable battery of the aerosol generating device, wherein the charging case further comprises a host microcontroller comprising the charge controller according to claim 30 configured to charge the rechargeable lithium-ion battery of the charging case, or wherein the charging case comprises a battery charger integrated circuit (IC) comprising the charge controller according to claim 30 configured to charge the rechargeable lithium-ion battery of the charging case.
